(19) United States
(12) Patent Application Publication
(10) Pub. No.: US 2023/0303725 A1
(43) Pub. Date: Sep. 28, 2023

(54) ALGINATE-BASED POLYMERS AND PRODUCTS, AND THEIR MANUFACTURE

(71) Applicant: KEEL LABS, INC., Brooklyn, NY (US)

(72) Inventors: Garret D. FIGULY, Wilmington, DE (US); Matthew E. GANDE, New York, NY (US); Minji KIM, Jersey City, NJ (US); Ray William MILLER, Kennett Square, PA (US)

(73) Assignee: KEEL LABS, INC., Brooklyn, NY (US)

(21) Appl. No.: 18/021,923

(22) PCT Filed: Aug. 13, 2021
(86) PCT No.: PCT/US2021/045944

§ 371 Date: Feb. 17, 2023

Related U.S. Application Data
(60) Provisional application No. 63/171,812, filed on Apr. 7, 2021.
(60) Provisional application No. 63/067,988, filed on Aug. 20, 2020.

(51) Int. Cl. C08B 37/00; D01F 9/04; D01D 5/06

(52) U.S. Cl. CPC C08B 37/0084; D01F 9/04; D01D 5/06

(57) ABSTRACT

Polymers comprising an alginate which is ionically crosslinked with hetero-substituted dicarboxylate-bridged multivalent cations, products including such polymers, and methods of their manufacture.

### PRIORITY

This application claims priority from U.S. Provisional Application No. 63/067,988, filed Aug. 20, 2020, and U.S. Provisional Application No. 63/171,812, filed Apr. 7, 2021, the disclosures of both of which are incorporated in their entirety by reference.

### FIELD

The present application provides alginate-based polymers and products, such as fibers. The alginate-based fibers can be used to produce textiles as compostable alternatives to petrochemical-based polymers in a range of applications, such as footwear, apparel, accessories, packaging, and furniture industries.

### BACKGROUND

Industry desires “cradle-to-grave” solutions for many products, such as textile products, whereby products can be made from renewable resources and then recycled or otherwise disposed of with little or no environmental impact. Attempts have been made to use natural products, such as alginates; however, the prior efforts have not been satisfactory because the products either did not have sufficient performance properties or used ingredients or solvents that resulted in adverse environmental impact.

### SUMMARY

Products are provided that generally possess and retain excellent properties, such as elasticity, resilience, and tenacity, making them well-suited for many applications, including textile fibers. For instance, fibers (including filaments and staple), yarns (fiber bundles), and other textile products (e.g., fabrics, such as woven and nonwoven fabrics) of the invention have unexpectedly excellent mechanical integrity and can be used in a range of industries with the ability to dramatically reduce the environmental damage caused by the textile industry.

The products can be made using alginates derived from kelp and thus can be considered plant-based, reducing the need for harmful feedstocks. Kelp is a type of seaweed, or macroalgae, that is grown globally in cold coastal waters. Kelp is one of the fastest growing and most rapidly replenishing organisms on earth. The growth of kelp does not utilize harmful fertilizers and pesticides, does not use arable land, and does not use fresh water for irrigation. Kelp efficiently absorbs carbon/CO₂ and filters pollutants from surrounding waters during growth. Farming kelp can help rebuild economic and ecological communities affected by overfishing and pollution by providing a new income source and improving marine habitats. Kelp reportedly sequesters 20 times more carbon per acre than terrestrial forests, and therefore products made from kelp have a high likelihood of being carbon neutral or negative.

The products are well-suited for use in current and future industrial applications, and have properties making them well-suited replacements for currently used products in many industries, particularly the textile industry. For instance, fibers can be spun and processed using already existing wet-spinning equipment and using chemistry that is safer for workers and the environment. Products have excellent characteristics, including for example, tensile strength (tenacity), break strength, elasticity, elongation, resilience, wet strength, modulus, and toughness, as compared to other alginate products, are compatible with the mechanical properties of rayon, and are biodegradable. Fiber manufacturing processability and efficiency is improved. The alginate-based products can readily absorb pigments and dyes using conventional methods.

The products are biodegradable and compostable, and can often be broken down by fungi and bacteria. Products may also be biodegradable in seawater and will not harm aquatic life even if consumed.

One advantage of the invention is that products can be made using water as a solvent. For instance, in wet spinning water can be used in the dope and coagulation bath, whereas many other wet-spinning processes are carried out using either petroleum-derived solvents or caustic solutions. This is advantageous from an environmental, processing, safety, and cost standpoint.

A polymer is provided comprising an alginate which is ionically crosslinked with hetero-substituted dicarboxylate-bridged multivalent cations wherein the dicarboxylates are present in at least about 0.05 molar equivalents with respect to the alginate carboxylate content.

A polymer is also provided comprising an alginate which is ionically crosslinked with hetero-substituted dicarboxylate-bridged multivalent cations, wherein the polymer is made by a process involving reacting alginate salt with at least about 1%, based on the weight of the alginate salt, of at least one hetero-substituted dicarboxylate.

In embodiments, the process involves reacting alginate salt with at least about 2.5%, at least about 5%, at least about 7.5%, and at least about 10%, based on the weight of the alginate salt, of the at least one hetero-substituted dicarboxylate.

In embodiments, the process involving reacting alginate salt with up to about 125%, up to about 100%, and up to about 75%, based on the weight of the alginate salt, of the at least one hetero-substituted dicarboxylate.

In embodiments, the dicarboxylate bridge is a C₃ -C₂₀ hetero-substituted aliphatic dicarboxylate.

In embodiments, the hetero-substituted dicarboxylate is a C₃ -C₁₂ hetero-substituted dicarboxylate.

In embodiments, the polymer is made by a process comprising: (a) combining: (i) at least one monovalent cationic alginate salt; (ii) at least one hetero-substituted dicarboxylate; and (iii) at least one multivalent cationic crosslinking agent; and (b) reacting them to form the polymer.

Provided is a process of preparing the polymer comprising: (a) combining: (i) at least one monovalent cationic alginate salt; (ii) at least one hetero-substituted dicarboxylate; and (iii) at least one multivalent cationic crosslinking agent; and (b) reacting them to form the polymer.

Embodiments comprise first combining the at least one monovalent cationic alginate salt with the at least one hetero-substituted dicarboxylate to form a mixture, followed by combining the mixture with the at least one multivalent cationic crosslinking agent to form the polymer.

Also provided is a process of preparing a shaped article from the polymer comprising: (a) shaping the polymer to form a shaped article. Shaped articles include fibers, films and granules. In embodiments, the shaped article is a fiber. In embodiments, the forming the fiber (shaped article) comprises air gap wet spinning.

Provided is a process of preparing a shaped article, comprising combining and reacting at least one monovalent cationic alginate salt, at least one C₃ -C₂₀ hetero-substituted dicarboxylate, and at least one multivalent cationic crosslinking agent, and with optionally one or more additives, to form the shaped article comprising a polymer including a crosslinked alginate. In embodiments, the shaped article is a fiber. In embodiments, the shaping comprises wet spinning.

There is further provided a process of preparing a shaped article from a polymer as discussed above, comprising: shaping the polymer to form a shaped article. In embodiments, the shaped article is a fiber; in embodiments, the shaped article is a film; and in embodiments, the shaped article is a fabric.

Further provided is a process of preparing a fiber by a wet spinning process which comprises:
a. Preparing a dope of at least one monovalent metal alginate salt and an at least one hetero-substituted dicarboxylate in solvent;
b. Extruding the dope through a spinneret to form fibers;
c. Drawing the fibers through at least one coagulation bath containing solvent and at least one multivalent cationic crosslinking agent; and
d. Drying the fibers.

In embodiments, the alginate salt is selected from the group consisting of sodium, potassium and ammonium alginate.

In embodiments, the alginate salt has a molecular weight of about 10,000 grams/mole to about 500,000 grams/mol.

In embodiments, the alginate salt has a G/M ratio of about 1 to about 2.5.

In embodiments, the hetero-substituted dicarboxylate is sodium, potassium, lithium, or ammonium hetero-substituted dicarboxylate.

In embodiments, the dope comprises about 0.5 to about 50% by weight of the monovalent metal alginate salt, by weight of the dope.

In embodiments, the dope is prepared with about 1 to about 125% of the at least one unsubstituted dicarboxylate based on the weight of the alginate salt.

In embodiments, the multivalent cationic crosslinking agent has cations selected from the group consisting of calcium, copper, iron, aluminum, zinc, magnesium, barium, chromium, cobalt, nickel, manganese, and mixtures thereof.

In embodiments, the coagulation bath contains about 0.02 to about 2 moles per liter of the at least one multivalent cationic crosslinking agent in the solvent.

In embodiments, the solvent of the dope is water. In embodiments, the solvent of the coagulation bath is water. In embodiments, both the solvent of the dope is water and the solvent of the coagulation bath is water.

In addition, provided are fabrics prepared from the fibers. In embodiments, the fabric is a knitted fabric. In embodiments, the fabric is a woven fabric. In embodiments, the fabric is a nonwoven fabric.

In embodiments, the hetero-substituted dicarboxylate is a hydroxyl substituted dicarboxylate. In embodiments, the hetero-substituted dicarboxylate is derived from a dicarboxylic acid selected from the group consisting of tartronic acid, malic acid, tartaric acid, citramalic acid, hydroxyglutaric acid, dihydroxyglutaric acid, hydroxyadipic acid, and saccharic acid.

In embodiments, the hetero-substituted dicarboxylate is an amino-substituted dicarboxylate. In embodiments, the amino-substituted dicarboxylate is derived from a dicarboxylic acid selected from the group consisting of aspartic acid and glutamic acid.

In embodiments, the hetero-substituted dicarboxylate is a halogen-substituted dicarboxylate. In embodiments, the halogen-substituted dicarboxylate is derived from a dicarboxylic acid selected from the group consisting of chloromalonic acid, bromomalonic acid, chlorosuccinic acid, bromosuccinic acid, dibromosuccinic acid, and bromoglutaric acid.

In embodiments, the hetero-substituted dicarboxylate is a keto-substituted dicarboxylate. In embodiments, the keto-substituted dicarboxylate is derived from oxaloacetic acid.

In embodiments, the hetero-substituted dicarboxylate is derived from a dicarboxylic acid selected from the group consisting of malic acid, tartaric acid, oxaloacetic acid, chlorosuccinic acid, glutamic acid, and aspartic acid.

In embodiments, the hetero-substituted dicarboxylate is mono-substituted.

In embodiments, the hetero-substituted dicarboxylate is poly-substituted.

In embodiments, the hetero-substituted dicarboxylate is sodium, potassium, lithium, or ammonium hetero-substituted dicarboxylate.

Embodiments comprise wet spinning a mixture of the at least one monovalent cationic alginate salt and the at least one C₃-C₂₀ hetero-substituted dicarboxylate into a bath comprising the at least one multivalent cationic crosslinking agent.

In embodiments, the polymer or fiber manufacturing process further comprises:

(1) combining:
(a) at least one C₃ -C₂₀ hetero-substituted dicarboxylic acid; and
(b) at least one base; and
(2) reacting them to form the hetero-substituted dicarboxylate.

Provided is a film made from the polymers and a process of making the films.

Provided is as foam made from the polymers and a process of making the foams.

Provided is a granular particle or pellet made from the polymers. Embodiments include a process of making the granular particle or pellet using a water-bath or spray process.

In embodiments, in the product or process of the invention, the linear hetero-substituted dicarboxylic acids used to prepare the dicarboxylates can be depicted by the following formula wherein y and z total 1-18; y is 1-18 and z is 0-17; X is OR₁, NR₂R₃, halogen (e.g., Cl and Br) and ═O; and R₁, R₂ and R₃, which may be the same or different, are selected from C₁-C₈ linear, branched, or cyclic alkyl groups or hydrogen.

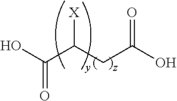

The skilled artisan will readily recognize the corresponding dicarboxylates. In embodiments, y and z are independently 1-6, y is 1-4 and z is 0-3.

Additional features and advantages of the present disclosure will be set forth in part in the description that follows, and in part will be apparent from the description, or may be learned by practice of the present disclosure. The objectives and other advantages of the present disclosure will be realized and attained by means of the elements and combinations particularly pointed out in the description and claims.

The foregoing general description and the following detailed description are exemplary and explanatory only to provide a further explanation of the present disclosure and are not restrictive of the scope of the subject matter encompassed by the claims.

### DETAILED DESCRIPTION

The particulars shown herein are by way of example and for purposes of illustrative discussion of the various embodiments of the present disclosure only, and provide what is believed to be the most useful and readily understood description of the principles and conceptual aspects of the disclosed subject matter. In this regard, no attempt is made to show details of the disclosed subject matter in more detail than is necessary for a fundamental understanding of the disclosure, the description making apparent to those skilled in the art how the several forms of the disclosure may be embodied in practice.

The following disclosure refers to more detailed embodiments. The disclosed subject matter, however, may be embodied in different forms and should not be construed as limited to the embodiments set forth herein. Although methods and materials similar or equivalent to those described herein can be used in the practice or testing of the invention, suitable methods and materials are described herein.

Unless otherwise defined, all technical and scientific terms used herein have the same meaning as commonly understood by one of ordinary skill in the art to which this disclosure belongs. The terminology used in the description herein is for describing particular embodiments only and is not intended to be limiting As used in the specification and claims, the singular forms “a,” “an,” and “the” are intended to include the plural forms as well, unless the context clearly indicates otherwise. Also, the phrases “at least one” and “one or more” are intended to be interchangeable, and their use are not intended to limit the scope of any described or claimed feature preceded by “a,” “an,” and “the” to a singular form.

All publications, patent applications, patents, and other documents mentioned herein are incorporated by reference in their entirety. Unless otherwise defined, all technical and scientific terms used herein have the same meaning as commonly understood by one of ordinary skill in the art to which this invention belongs. In case of conflict, the present specification, including definitions, will control.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the specification and claims are approximations that may vary depending upon the desired properties sought to be obtained by a particular embodiment. At the very least, and not as an attempt to limit the application of the doctrine of equivalents to the scope of the claims, each numerical parameter should be construed in light of the number of significant digits and ordinary rounding approaches. When the term “about” is used in describing a value or an end-point of a range, the disclosure should be understood to include the specific value or end-point referred to.

Notwithstanding that the numerical ranges and parameters setting forth the broad scope of the disclosed subject matter are approximations, the numerical values set forth in the specific examples are reported as precisely as possible. Any numerical value, however, inherently contains certain errors necessarily resulting from the standard deviation found in the method used to obtain the value. Every numerical range given throughout this specification includes every narrower numerical range that falls within such broader numerical range, as if such narrower numerical ranges were all expressly written herein.

When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range.

All percent measurements in this application, unless otherwise stated, are measured by weight based upon 100% of a given sample weight. Thus, for example, 30% represents 30 weight parts out of every 100 weight parts of the sample. Unless stated otherwise, all percentages, parts, ratios, etc., are by weight.

The present disclosure includes a large number and variety of components that are contemplated for inclusion in the disclosed compositions. It should be recognized that when the inventors expressly contemplate including such components, they also expressly contemplate excluding such components. Thus, all components disclosed herein are expressly contemplated for exclusion as well.

Except where expressly noted, trademarks are shown in upper case.

As used herein, the terms “comprises,” “comprising,” “includes,” “including,” “containing,” “characterized by,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

The transitional phrase “consisting of” excludes any element, step, or ingredient not specified in the claim, closing the claim to the inclusion of materials other than those recited except for impurities ordinarily associated therewith. When the phrase “consists of” appears in a clause of the body of a claim, rather than immediately following the preamble, it limits only the element set forth in that clause; other elements are not excluded from the claim as a whole.

The transitional phrase “consisting essentially of” limits the scope of a claim to the specified materials or steps and those that do not materially affect the basic and novel characteristic(s) of the claimed invention. “A ‘consisting essentially of’ claim occupies a middle ground between closed claims that are written in a ‘consisting of’format and fully open claims that are drafted in a ‘comprising’ format.”

Where applicants have defined an invention or a portion thereof with an open-ended term such as “comprising,” it should be readily understood that (unless otherwise stated) the description should be interpreted to also describe such an invention using the terms “consisting essentially of” or “consisting of.”

The invention is directed to polymers having an alginate “backbone” that are ionically crosslinked with hetero-substituted dicarboxylate bridged multivalent cations, their manufacture and use. (The term “backbone” is simply used in this description to refer to the fact that the polymeric components are substantially alginate or alginate-derived. It is not intended to imply that the entire polymeric component must be alginate as alginate is recognized in the art.) The hetero-substituted dicarboxylate is essentially the di-anion of a hetero-substituted dicarboxylic acid. The salt is generally preferred since it is water soluble and works well in many applications, such as wet-spinning of fibers. Without wishing to be bound by any particular theory of operation, it is believed the multivalent cation (e.g., calcium or other cations) from the crosslinking agent replaces the sodium or other metal counterions of the dicarboxylic acid salt and connects the hetero-substituted dicarboxylate to the anion of the carboxylate groups of the alginate. In embodiments, the polymers of the invention can be characterized as crystalline, semi-crystalline or amorphous.

There have been other attempts at making alginate fibers but those attempts do not use the presently disclosed concepts. For example, CN 101033564A describes preparing calcium alginate fibers by wet spinning using calcium chloride crosslinking agent. These fibers do not have adequate properties for commercial use. Other documents, such as U.S. Pat. No. 7,270,654, mention use of alginates in making shaped articles, but none of them teach products having properties suitable for industrial use and that later have minimal or no environmental impact.

WO 2020/118080 A1 is directed to alginate compositions comprising sodium alginate, methyl cellulose, and a polyol plasticizer (glycerol), as well as their use in wet-spinning of fibers, and fabrics and films

The presently inventive polymer is made from (a) the alginate backbone, (b) the hetero-substituted dicarboxylate, and (c) the multivalent cations. The relative proportions of each will generally be dependent on the molecular weight, or chain length, of the dicarboxylate used, and valency and weight of the multivalent cation(s) used. While embodiments may include only one type of alginate, hetero-substituted dicarboxylate, or multivalent cation, more than one type of each component may be included such that, for example, mixtures of one or more of alginates, dicarboxylates and multivalent cations can be used.

In the polymers of the invention, the dicarboxylates are present in at least about 0.05 molar equivalents with respect to the alginate carboxylate content. Here, it should be understood that alginate polymers have carboxylates along the chain and reference is to how many dicarboxylates there are per carboxylates in the alginate chains.

In embodiments, the dicarboxylate bridges are present in at least about 0.1 and at least about 0.2 molar equivalents with respect to the alginate carboxylate content. In embodiments, the dicarboxylate bridges are present in up to about 1.0, up to about 0.5 and up to about 0.75, molar equivalents with respect to the alginate carboxylate content.

In embodiments, the alginate backbone can comprise from at least about 20 weight % of the polymer, or at least about 50, 60, 70, 80, 90, 92.5 or 95 weight % of the polymer. In embodiments, the alginate backbone can comprise up to about 97.5 weight % of the polymer. In embodiments, the alginate backbone can comprise up to about 95 weight % of the polymer.

In embodiments, the hetero-substituted dicarboxylate can comprise at least about 1 weight % of the polymer, or at least about 2.5, 5, 10, 20, 30, 40, or 50 weight % of the polymer.

### Starting Materials

The polymers can be made from: at least one monovalent cationic alginate salt; at least one C₃-C₂₀ hetero-substituted dicarboxylate; and at least one multivalent cationic crosslinking agent.

Alginates

The polymers of the invention have an alginate backbone. Any suitable alginate cationic salt can be used to make the polymers of the invention. They can be made using at least one alginate that is derived from one or more alginate salts with a monovalent cation. Examples include, but are not limited to, sodium, potassium, and ammonium salts. In embodiments, the polymers are made using sodium alginate.

Naturally occurring alginates are polysaccharides consisting of linear copolymers of β-(1-4) linked d-mannuronic acid units (M-Units) and β-(1-4) linked 1-guluronic acid units (G-Units) connected via glycosidic bonds. The units can be found in homopolymer blocks (MM or GG) or a random copolymer blocks (GM) within the polymer chain. Alginates salts are commonly described by their ratio of G-units to M-units, or G/M ratio. The G/M ratio can vary widely but is typically found to be between 3:1 and 1:3. Alginates useable within the present invention may be naturally derived (from, for example, kelp), or may be made through biotechnological methods. The present invention is not limited by the source of the alginate.

Alginates useable within the present invention may have their original, i.e., “natural,” structure, or may be chemically modified, such as for example, propylene glycol alginate. Such modification is acceptable provided that it does not unacceptably interfere with the basic concept of the invention.

Alginate salts with any suitable G/M ratio can be used. The G to M ratio is determined by High Performance Anion Exchange - Pulsed Amperometric Chromatography (HPAE-PAC).

In embodiments, the G/M ratio is at least about 0.5. In embodiments, the G/M ratio is at least about 1. In embodiments, the G/M ratio is at least about 1.5. The G/M ratio may be up to about 2.5. In embodiments, the G/M ratio may be up to about 2. One contemplated alginate salt has a G/M ratio about 1.8. (The person of ordinary skill in the art would readily recognize that ratios can be described using single numbers, so that a G/M ratio of 0.5 is the same as 0.5/1 and a G/M ratio of 2 is the same as a ratio of 2/1.)

Alginate salts can be described by their molecular weight and/or viscosity. Herein, they are described relative to each. As used herein, molecular weight is measured multiangle light scattering (MALS) for best efficiency and accuracy. This method yields weight average molecular weights (M_{w}) and any reference to alginate molecular weight herein is to M. Molecular weight directly impacts the measured viscosity in solution. High viscosities are generally caused by high average molecular weights. To measure viscosity directly, typically a 1% by weight aqueous solution is kept at 20° C. and viscosity is acquired with a Brookfield viscometer. The skilled artisan will readily recognize that the viscosities presented do not correlate exactly to the described molecular weights, and that one or both of these properties can be used in order to select alginate salts useful for a given application.

Alginate salts may have, in embodiments, a molecular weight of at least about 10,000 grams/mole, at least about 15,000 grams/mole, at least about 50,000 grams/mole, or at least about 90,000 grams/mole. In embodiments, alginate salts have a molecular weight of up to about 500,000 grams/mole, up to about 325,000 grams/mole, or up to about 250,000 grams/mole. In terms of viscosity, alginate salts may have a viscosity of at least about 15 cP, at least about 20 cP, at least about 25 cP, at least about 30 cP, at least about 35 cP, or at least about 40 cP. Alginate salts may have a viscosity of up to about 1000 cP, up to about 900 cP, up to about 800 cP, up to about 700 cP, up to about 600 cP, up to about 500 cP, up to about 400 cP, or up to about 325 cP.

Embodiments may have both high molecular weight and a high G/M ratio. In these embodiments, alginate salts can have a molecular weight of about 200,000 to about 500,000 grams/mole, or a viscosity of about 150 cP to about 1,000 cP, and a G/M ratio of about 1.5 up to about 2.5. In embodiments, alginate salts can have a molecular weight of about 200,000 to about 500,000 grams/mole, or a viscosity of about 150 cP to about 1,000 cP, and a G/M ratio of about 1.5 up to about 2.0.

Embodiments may have high molecular weight and a low G/M ratio. In these embodiments, alginate salts have molecular weight of about 200,000 to about 500,000 grams/mole or viscosity of about 150 cP to about 1,000 cP, and a G/M ratio of about 0.5 to about 0.75.

Embodiments may have low molecular weight and a high G/M ratio. In these embodiments, alginate salts can have molecular weight of about 30,000 to about 200,000 grams/mole or viscosity of about bout 20 cP to about 150 cP, and a G/M ratio of about 1.5 up to about 2.5. In embodiments, alginate salts can have molecular weight of about 30,000 to about 200,000 grams/mole or viscosity of about bout 20 cP to about 150 cP, and a G/M ratio of about 1.5 up to about 2.0.

Embodiments may have low molecular weight and a low G/M ratio. In these embodiments, alginate salts can have molecular weight of about 30,000 to about 200,000 grams/mole or viscosity of about bout 20 cP to about 150 cP, and a G/M ratio of about 0.5 to about 0.75.

Embodiments may have medium G/M ratios. In embodiments where medium G/M ratios are present, a G/M ratio of about 0.75 to about 1.5 may be specified.

Examples of alginate salts useful in the practice of this invention are commercially available. Examples include, for example: Algin IL-6G (Kimica, Tokyo Japan); Algin I-3G-80 (Kimica); Algin 1-8 (Kimica); ALGOGEL® 3541 (Algaia, Paris France); ALGOGEL® 7041 (Algaia, Paris France); SATIALGINE® S1600N (Algaia); SATIALGINE® S2ONS (Algaia); ProNova SLM 100 (International Flavors & Fragrances NovaMatrix, Sandvika Norway); ProNova SLG 20 (International Flavors & Fragrances NovaMatrix); Alginic acid sodium salt (Sigma Aldrich, St. Louis Missouri). In wet-spinning, use of a low molecular weight in conjunction with a high G/M ratio (such as Algin IL-6G) is preferred for processibility.

### Dicarboxylates

The polymers of the invention are ionically crosslinked with dicarboxylate bridged multivalent cations. The term “dicarboxylate” refers to mono- or poly- hetero-substituted dicarboxylic acid salts. The skilled artisan will readily recognize that dicarboxylates have positive counterions associated with their carboxyl groups.

The dicarboxylate bridge is derived from any useful hetero-substituted dicarboxylate. In embodiments, the main carbon chain only conations carbon atoms. By “hetero-substituted” is meant that there are substituents that contains an atom other than a carbon or hydrogen atom attached to the main carbon chain or cyclic group. For the avoidance of doubt, substituents also include hydrocarbon substituents, such as alkyl group (e.g., methyl group) or aryl group.

In embodiments, the hetero-substituted dicarboxylate bridge is a C₃-C₂₀ hetero-substituted dicarboxylate bridge and is derived from a C₃ -C₂₀ hetero-substituted dicarboxylate obtained from a C₃-C₂₀ hetero-substituted dicarboxylic acid.

The dicarboxylates may be mono- or poly-substituted meaning the dicarboxylates may have one or more substituents. If poly-substituted, the dicarboxylate may have two or more substituents, at least one of which should be a hetero atom containing substituent. In embodiments, the dicarboxylates have one substituent and it is a hetero-containing substituent. In embodiments, the dicarboxylates have two or more substituents that are hetero-containing substituents. In embodiments, the dicarboxylates have two substituents that are hetero-containing substituents. In embodiments, the dicarboxylates have two substituents, one of which is a hetero-containing substituent and the other substituent only contains carbon and hydrogen atoms.

The dicarboxylates or dicarboxylic acids can contain linear, branched or cycloaliphatic hydrocarbon chains. In embodiments, reference is to linear or branched hydrocarbons. In embodiments, linear hydrocarbons are selected.

Herein, when referring to the bridge, the salt, and the acid, the person of ordinary skill in the art will readily recognize the correlation. Examples include, for example, C₃ -C₁₂ hetero-substituted dicarboxylates obtained from C₃ -C₁₂ hetero-substituted dicarboxylic acids. In the following discussion, when referring to features of the bridge, salt, or acid the person of ordinary skill in the art should also read the description to encompass the corresponding bridge, salt, or acid.

Examples of hetero-substituted dicarboxylic acids useful in the invention include but are not limited to malic, tartaric, oxaloacetic, chlorosuccinic acid, glutamic acid, and aspartic acid.

In embodiments, the hetero-substituted dicarboxylic acid is a hydroxyl substituted dicarboxylic acid. Examples are tartronic acid, malic acid, tartaric acid, citramalic acid, hydroxyglutaric acid, dihydroxyglutaric acid, hydroxyadipic acid, and saccharic acid (also known as glucaric acid).

In embodiments, hetero-substituted dicarboxylic acid is an amino-substituted dicarboxylic acid. Examples are aspartic acid and glutamic acid.

In embodiments, hetero-substituted dicarboxylic acids is a halogen-substituted dicarboxylic acid. Examples are chloromalonic acid, bromomalonic acid, chlorosuccinic acid, bromosuccinic acid, dibromosuccinic acid, and bromoglutaric acid.

In embodiments, the hetero-substituted dicarboxylic acids is a keto-substituted dicarboxylic acid. An example is oxaloacetic acid.

The specific examples of dicarboxylic acids listed above are for reference only and the present invention is not limited to these examples.

In embodiments, the linear hetero-substituted dicarboxylic acids used to prepare the dicarboxylates can be depicted by the following formula where X is OR₁, NR₂R₃, halogen (e.g., Cl and Br) and ═O:

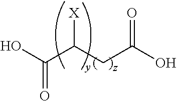

The skilled artisan will readily recognize that the diagram is showing that there are two potential types of carbon group, so that when group z is present, group y and group z may be in any order along the chain. In addition, the skilled artisan will readily recognize the corresponding dicarboxylates.

In embodiments, y and z total 1-18, y is 1-18 and z is 0-17.

In embodiments, y and z are independently 1-6, y is 1-4 and z is 0-3.

In embodiments, y and z are independently 1-4. In embodiments, y is 2. In embodiments, y is 1.

The skilled artisan will readily recognize the values of z and y for the dicarboxylic acids and their corresponding dicarboxylates described above.

In embodiments, X is OR₁ and each R₁ can be the same or different and is selected from C₁-C₈ linear, branched or cyclic alkyl groups or hydrogen. In embodiments, X is OR₁ and each R₁ can be the same or different and is selected from C₁-C₄ linear or branched alkyl groups or hydrogen. In embodiments, OR₁ is hydroxyl.

In embodiments, X is NR₂R₃ and each R₂ and R₃ can be the same or different and is selected from C₁-C₈ linear, branched or cyclic alkyl groups or hydrogen. In embodiments, X is NR₂R₃ and each R₂ and R₃ can be the same or different and is selected from C₁-C₄ linear or branched alkyl groups or hydrogen. In embodiments, NR₂R₃ is NH₂.

In embodiments, X is both OR₁ and X is NR₂R₃ and R₁, R₂ and R₃, which can be the same or different, are selected from C₁-C₈ linear, branched, or cyclic alkyl groups or hydrogen. In embodiments, R₁, R₂ and R₃, which can be the same or different, are selected from C₁-C₄ linear or branched alkyl groups or hydrogen. In embodiments, R₁, R₂ and R₃, which can be the same or different, are selected from C₁-C₄ linear alkyl groups.

In embodiments, X is halogen. In embodiments, X is Cl. In embodiments, X is Br.

In embodiments, X is ═O (i.e., a ketone substituent group or oxygen attached by two bonds).

Mixtures of one or more dicarboxylic acid can be used in any embodiment, and in other instances use of only one dicarboxylic acid may be preferred. In embodiments, the mixtures consist of hetero-substituted dicarboxylic acids or specific types of hetero-substituted dicarboxylic acids, such as only containing mono- or poly-hydroxy-substituted aliphatic dicarboxylates. In embodiments, the mixtures consist of hetero-substituted dicarboxylic acids along with one or more unsubstituted dicarboxylates.

When referring to “aliphatic” dicarboxylates or dicarboxylic acids, reference is to dicarboxylates or dicarboxylic acids with linear, branched or cycloaliphatic hydrocarbon chains. In embodiments, reference is to linear or branched hydrocarbons. In embodiments, linear hydrocarbons are selected.

In embodiments, the unsubstituted dicarboxylate is aliphatic and the carbon chain is saturated. In this embodiment, the dicarboxylate is, for example, derived from a saturated aliphatic dicarboxylic acid selected from the group consisting of oxalic, malonic acid, succinic acid, glutaric acid, adipic acid, pimelic acid, suberic acid, azelaic acid, sebacic acid, undecanedioic acid, dodecanedioic acid, brassylic acid, and tetradecanedioic acid. In embodiments, the dicarboxylate is derived from an unsubstituted aliphatic dicarboxylic acid selected from the group consisting of succinic acid, glutaric acid, adipic acid, pimelic acid, suberic acid, azelaic acid, sebacic acid, and mixtures thereof. In embodiments, the dicarboxylate is derived from a saturated aliphatic dicarboxylic acid selected from the group consisting of succinic acid, glutaric acid, adipic acid, suberic acid, azelaic acid, sebacic acid, and mixtures thereof. In embodiments, the saturated aliphatic dicarboxylate is derived from a dicarboxylic acid selected from the group consisting of succinic acid, adipic acid, sebacic acid, and mixtures thereof. In embodiments, the unsubstituted aliphatic dicarboxylic acid is sebacic acid. In embodiments, the dicarboxylic acid is adipic acid. In embodiments, the dicarboxylic acid is glutaric acid. In embodiments, the dicarboxylic acid is succinic acid.

In embodiments, the unsubstituted dicarboxylate is aliphatic and the carbon chain is unsaturated. Examples of unsaturated aliphatic dicarboxylic acids useful in the invention include but are not limited to maleic and fumaric acid.

Dicarboxylates can be formed by reacting a dicarboxylic acid and base. These dicarboxylates can be purchased or easily prepared. In embodiments, they are prepared and isolated in a separate reaction in advance of use. Alternatively, they can be prepared by sequential addition.

Examples of dicarboxylates include but are not limited to sodium, potassium, lithium, or ammonium dicarboxylates. Embodiments use sodium dicarboxylate. Embodiments use potassium dicarboxylate. Mixtures of dicarboxylates can be used.

For use in wet-spinning and other applications where the dicarboxylic acid or salt is dissolved in a solvent, such as water, solubility is important and it may be necessary to use co-solvents or alternative monovalent counterions to insure sufficient solubility of the higher molecular weight dicarboxylates.

Any suitable base can be used for making the dicarboxylates. For wet-spinning, it may be desirable to use salts that are soluble in the solvent, most commonly water. In embodiments, the base is selected from sodium hydroxide, potassium hydroxide, ammonium hydroxide, sodium carbonate, potassium carbonate, lithium carbonate, lithium hydroxide, sodium bicarbonate, potassium bicarbonate, lithium bicarbonate, and mixtures thereof. In embodiments, the base is sodium hydroxide. In embodiments, the base is potassium hydroxide.

Making of the dicarboxylates is well-known in the art, and can be done by using solutions or solids, etc., using any technique, including conventional techniques. As an example, sodium hydroxide can be purchased in solution or as a solid, and then reacted with a dicarboxylic acid. Caustic solutions, such as 50% sodium hydroxide solution in water, are readily available. Caustic can also be purchased as a solid.

### Crosslinking Agent

In the polymers of the invention, the alginate backbone is ionically crosslinked with dicarboxylate bridged by multivalent cations. That is, through ionic bonding, at least one multivalent cationic crosslinking agent attaches the dicarboxylate to the alginate backbone.

There can also be direct ionic crosslinking by the multivalent cations. This would, of course, be dependent on stoichiometry and can be used to adjust the properties of the polymers and resultant products.

Examples of multivalent cations are calcium, copper, iron, aluminum, zinc, magnesium, barium, chromium, cobalt, nickel, and manganese, and mixtures thereof. Crosslinking multivalent cations may be selected from calcium, copper, iron, aluminum, zinc, cobalt, barium, and mixtures thereof. In embodiments, the crosslinking cation is selected from calcium, copper, iron, aluminum, and zinc, and mixtures thereof. In embodiments, the crosslinking cation is selected from calcium, copper, aluminum, and mixtures thereof. In one specific embodiment, the crosslinking cation is calcium.

Any suitable cationic crosslinking agent that is sufficiently soluble in the amount of water or other solvent system (e.g., glycerol) used to carry out the reaction can work. Examples of crosslinking agents include, for example, calcium chloride, barium chloride, aluminum chloride, copper chloride, copper sulfate, aluminum sulfate, iron sulfate, and zinc sulfate. More particular crosslinking agents are calcium chloride, barium chloride, calcium bicarbonate, copper sulfate, aluminum sulfate, iron sulfate, and zinc sulfate. One specific crosslinking agent is calcium chloride.

### Celluloses

Celluloses can be added to the polymers, such as described in WO 2020/118080 A1. Examples of suitable celluloses include methylcellulose, ethylcellulose, carboxymethyl cellulose, hydroxethyl cellulose, hydroxpropyl cellulose, cellulose acetate, cellulose diacetate, cellulose triacetate, cellulose acetate-propionate, cellulose acetate-butyrate, nitrocellulose, other cellulose derivatives, or combinations thereof. In many embodiments, celluloses are not used.

### Additives

The polymers and products made with them may contain one or more additives, examples of which are known in the art, and which may be used in amounts suitable for the desired properties, typical of those described in the art. Examples of these types of additives are well known in the art and include pigments, dyes, whitening agents, or other coloring agents, optical brighteners, stabilizers (e.g., flame or fire retardants, light stabilizers, thermal stabilizers, antioxidants), plasticizers, delusterants (e.g., TiO₂, CaCO₃, silicon dioxide), viscosity modifiers, surfactants, antimicrobials, anti-static agents, lubricants, processing aids, slip additives, antiblock agents, release agents, fillers, and other components known in the art to be useful additives. (Some additives, such as TiO₂, may fulfill more than one of these purposes.) It will be readily recognized that additives may be incorporated in various process steps and using a variety of techniques.

### The Polymer and Products

The products of the invention are well-suited for use in current and future industrial applications, and have properties making them well-suited replacements for currently used products in many industries, particularly the textile industry. The products of the invention possess and retain excellent properties, such as elasticity, resilience and tenacity, making them well-suited for many applications, including textile fibers and films. For instance, fibers (including filaments and staples), yarns (fiber bundles), and other textile products (e.g., fabrics, such as woven and nonwoven fabrics) of the invention have unexpectedly excellent mechanical integrity and can be used in a range of industries with the ability to dramatically reduce the environmental damages caused by the textile industry.

Various types of fibers can be made using the invention, including filaments and staple fibers. These terms are used in their ordinary commercial meanings. Typically, herein, “filament” is used to refer to the continuous fiber on the spinning machine.

“Staple fiber” or “staple” is used to refer to short fibers or cut filaments. For instance, staple fibers for nonwoven fabrics may have lengths of at least about 1 inch. In some embodiments, the length is at least about 1.25 inches or even more. Depending on the use, lengths can be up to about 6 inches or more. In embodiments, the length is up to about 4 inches. In embodiments, the length is up to about 2 inches.

Embodiments are focused on primarily or only using the polymers of this invention (with additives), sometimes referred to in the art as monocomponent fibers or configurations. However, other embodiments can include the polymers of this invention with other polymers. That is, the polymers of the invention may be used in multicomponent (e.g., bicomponent) configurations, including conventional sheath/core and side-by-side multicomponent configurations, and multiconstituent (e.g., biconstituent) configurations. Where there are multiple polymers (including the indicated one or more alginates) present, any suitable combinations of the polymers, including the multicomponent and multiconstituent configurations, can be employed. The types and proportions of the polymers used can be readily determined by those of ordinary skill in the art, without undue experimentation. For instance, those embodiments can include very small amounts of the polymer of the invention to large amounts of the polymers. As such, embodiments can contain at least about 5%, at least about 10%, at least about 15%, at least about 20%, at least about 30%, at least about 40%, at least about 50%, at least about 75%, at least about 85%, at least about 90%, at least about 95%, of the polymer, all by weight of the fiber.

Yarns (also known as “bundles”) preferably comprise many staples or filaments.

Fiber size and shape will vary by application, and can be as low as 0.1 denier per filament (dpf) or smaller, and as large as 300 dpf or larger. For many textile applications, the fiber of the present invention has a denier per filament (dpf) of at least about 0.1, at least about 0.5, and has a denier per filament (dpf) of up to about 30, up to about 10, up to about 5, more preferably up to about 3, depending on the end-use. These sizes are for exemplary purposes and the skilled artisan is familiar with the desired sizes for various purposes.

The invention can also be used to prepare monofilaments. Monofilaments will often be about 10 to about 300 dpf. Monofilaments, monofilament yarns, and use thereof are well known in the art.

The fibers (staples or filaments) can be any shape, including for example, round, substantially round, oval, or have other shapes, such as grooved, mostly flat, dog-bone, octalobal, delta, sunburst (also known as sol), scalloped oval, trilobal, tetra-channel (also known as quatra-channel), scalloped ribbon, ribbon, starburst, snowman, etc. They can be solid, hollow or multi-hollow. In embodiments, the fibers are round or substantially round, solid filaments. In embodiments, the fibers are flat or substantially flat, solid filaments. In embodiments, the fibers are ribbon or scalloped ribbon filaments.

The invention includes fabrics made of the fibers, including knitted, woven, non-woven, and other types of fabrics. Woven or knitted fabrics can be made from and not limited to monofilament, multifilament, and spun yarns. Nonwoven fabrics are generally made either from staple fiber through a wet laid, air laid, or carding process, or through direct formation using an electrospinning or solution blown process. Fabrics can include blends with other types of fibers or filaments, including spinning together fibers of alginate with other natural and synthetic fibers, and coating existing yarns with alginate hydrogels or filaments.

The invention includes all types of textile end-uses, such as apparel (e.g., clothing or fabrics for footwear) or staple fibers and filaments useful in technical textiles, such as carpeting, car interiors, wall covering.

Yarns and fabrics include blends with fibers (staples and filaments) such as those made of cotton, animal materials (e.g., wool and chitosan), regenerated celluloses (e.g., viscose (Rayon) and lyocell (Rayon), compostable polymers such as polylactic Acid (PLA) and polyhydroxybutyrate (PHA), bast (e.g., linen and hemp), and protein based materials (e.g., silk). Blends can also include synthetic fibers (staples and filaments) such as aramid (e.g., KEVLAR® and NOMEX®), nylon (e.g., nylon 6; nylon 6,6; nylon 6,10; nylon 5,6; and nylon 6,12), polyester (e.g., polyethylene terephthalate (PET), polytrimethylene terephthalate (PTT) (SORONA®), polybutylene terephthalate (PBT) (polytetramethylene terephthalate) and polypropylene. The skilled artisan will readily recognize the desired sizes and other properties of those fibers. For example, filament and staple fiber blends can contain at least about 10 weight %, at least about 25 weight %, at least about 30 weight %, at least about 40 weight %, at least about 45 weight %, at least about 50 weight %, at least about 55 weight %, at least about 60 weight %, at least about 75 weight %, and at least about 90 weight % of the filaments or staple fibers of the invention with commercially available filaments or staple fibers of the other polymers which are at least about 0.5 dpf, at least about 1 dpf, at least about 2 dpf, at least about 3 dpf, at least about 5 dpf and at least about 10 dpf filaments or larger, depending on the use. In embodiments, the fibers or filaments are up to at least about 10 dpf and up to at least 5 dpf.

Yarns and fabrics can contain small amounts (e.g., at least about 1, at least about 2, at least about 3, at least about 4, and at least about 5 weight %, and up to about 10 weight % or up to about 5 weight %) of elastic filaments and staple fibers (e.g., spandex, elastane, or sheath-core and side-by-side PET/PTT, PET/PBT and PTT/PBT bicomponent fibers) having appropriate size and stretch characteristics can be added for desired fiber and fabric properties. The stretch filaments and fibers can have sizes of at least about 0.5 dpf, at least about 1 dpf, at least about 2 dpf, at least about 3 dpf and at least about 5 dpf. In embodiments, the filaments and fibers have sizes up to about 10 dpf and up to about 5 dpf.

The invention also includes films, foams, granular particles, and hydrogel of the polymers. Films are made by conventional methods including but not limited to spin coating, spin casting, solvent casting and single layer or multilayer co-extrusion. Foams can be made by conventional methods including but not limited to open pore (continuous dispensing), and closed pore.

Granular particles or pellets can be made using a water-bath (e.g., cutting taking place in the water-bath) or spray process. Examples of granular particles include but are not limited to microspheres or microencapsulations for agricultural product delivery (e.g., pesticides such as insecticides, fungicides, and herbicides, and other types of agricultural products), drug delivery, spraying scents, or for encapsulating powder for laundry and dish detergent. Granular particles can also be used to encapsulate cells or bacteria.

It will readily be recognized that many other products can be made using the polymers of the invention using conventional processes.

Provided is a process of preparing the polymer comprising: (a) combining: (i) at least one monovalent cationic alginate salt; (ii) at least one C₃ -C₂₀ hetero-substituted dicarboxylate; and (iii) at least one multivalent cationic crosslinking agent; and (b) reacting them to form the polymer.

Embodiments comprise first combining the at least one monovalent cationic alginate salt with the at least one C₃ -C₂₀ hetero-substituted dicarboxylate to form a mixture, followed by combining the mixture with the at least one multivalent cationic crosslinking agent to form the polymer.

In addition, provided is a process of preparing a shaped article from the polymer comprising shaping the polymer to form a shaped article. In embodiments, the shaped article is a fiber. In embodiments, the shaped article is a film In embodiments, the shaped article is a fabric.

Embodiments comprises combining the alginate and the hetero-substituted dicarboxylate, followed by shaping, followed by addition of the crosslinking agent.

In embodiments, the process involving reacting alginate salt with at least about 2.5%, at least about 5%, at least about 7.5%, and at least about 10%, based on the weight of the alginate salt, of the at least one hetero-substituted dicarboxylate. In embodiments, the process involving reacting alginate salt with up to about 125%, up to about 100%, and up to about 75%, based on the weight of the alginate salt, of the at least one hetero-substituted dicarboxylate.

In embodiments a dope is used. In those embodiments, (a) the dope comprises about 0.5 to about 50% by weight of the monovalent metal alginate salt, by weight of the dope, (b) about 1 to about 125% of at least one hetero-substituted dicarboxylate based on the weight of the alginate salt in the dope, and the balance primarily or substantially water. The weight of the monovalent metal alginate salt may be at least about 1%, or at least about 2%, or at least about 4%, by weight. The weight of the monovalent metal alginate salt may be up to about 40%, or up to about 25%, or up to about 18%.

In embodiments, the process is carried out in a bath containing about 0.02 to about 2 and about 0.05 to about 1.5 moles per liter of the at least one multivalent cationic crosslinking agent in a solvent. In embodiments, the solvent is water.

### Wet Spinning

In embodiments, the invention is directed to fibers (such as continuous filaments and staple fibers), yarns (e.g., spun yarns), and other textile products (e.g., fabrics, such as woven and nonwoven fabrics), such as wet-spun fibers, yarns and textile products. One advantage of the fibers, yarns, and other textile products is that they can be made using already existing industrial equipment.

One manufacturing process involves wet-spinning. One particular wet-spinning process comprises the following steps: preparing a dope of at least one monovalent cation alginate salt and at least one C₃-C₂₀ dicarboxylate in solvent; extruding the dope through a spinneret to form fibers; drawing the fibers through a coagulation bath containing solvent and at least one multivalent cationic crosslinking agent; and drying the fibers. One or more coagulation baths may be used.

The skilled artisan will readily recognize the advantages of using water as a solvent. This is advantageous from an environmental, processing, safety, and cost standpoint. One advantage of the invention is that in embodiments, the solvents in the dope and coagulation bath are water.

The temperature of the dope and bath can vary and may be the same or different. As the preferred solvents include water, the temperatures will generally be greater than 0° C. and less than 100° C. As multiple baths may be used, the temperatures in those baths may also be varied to achieve a desired effect.

The dope can include common additives, such as but not limited to light and thermal stabilizers, pigments and dyes, antimicrobials, delustering agents, fillers, flame retardants, plasticizers, viscosity modifiers, processing aids and other components known in the art to be useful additives.

The coagulation bath can include other components such as, but not limited to, non-crosslinking ions (e.g., sodium and potassium), dyes, surfactants, antiblocks, slip agents, and flame retardants.

In embodiments, the free dicarboxylic acid and a base are mixed in solvent to form the dicarboxylate, and the alginate salt is then added.

In embodiments, the process further comprises a washing step following the drawing and prior to the drying. In embodiments, the drawing is carried out in one or more drawing steps.

In embodiments, the process further comprises cutting the fibers into staple fibers.

In embodiments, the process further comprises winding the fibers into continuous filament.

The drawing can be carried out in one or more drawing steps.

In embodiments, the process further comprises texturizing the filaments. In embodiments, the process further comprises crimping.

In embodiments, the process further comprises applying a spin finish. Examples of spin finishes are known in the art.

In embodiments, (a) the dope comprises about 0.5 to about 50% by weight of the monovalent metal alginate salt, by weight of the dope, (b) about 1 to about 125% of at least one hetero-substituted dicarboxylate based on the weight of the alginate salt in the dope, and the balance primarily or substantially water. The weight of the monovalent metal alginate salt may be at least about 1%, or at least about 2%, or at least about 4%, by weight. The weight of the monovalent metal alginate salt may be up to about 40%, or up to about 25%, or up to about 18%. The weight of the hetero-substituted dicarboxylate may be at least about 2.5%, at least about 5%, or at least about 7.5%, or at least about 10%, by weight of the alginate salt in the dope. The weight of the hetero-substituted dicarboxylate may be up to about 100% by weight, or up to about 75%, by weight of the alginate salt in the dope.

The coagulation bath may contain at least about 0.02, at least about 0.05, or at least about 0.075, moles per liter of at least one multivalent cationic crosslinking agent. The coagulation bath may contain up to about 2, up to about 1.5, or up to about 0.75, moles per liter of at least one multivalent cationic crosslinking agent.

Crosslinking takes place in one or more coagulation baths. Thus, the process may be carried out using one or more coagulation baths set up independently or in series, and optionally can involve use of counterflow for improving curing efficiency. To allow sufficient crosslinking to occur, the fibers can spend at least about 2 seconds, or at least 5 seconds, in the one or more coagulation baths. The fibers may spend up to about 20 seconds, or up to about 15 seconds in the one or more coagulation baths.

Various finishes, such as spin finishes and/or overfinishes, may be applied as desired, providing antistatic, lubricant, and/or such other properties as may be desired for processing the fibers of this invention into a particular article of manufacture.

The invention also includes methods to color the alginate-based fibers, yarns, or textiles including a traditional dip-dying or a dope-dyeing process, wherein a colorant is added into the dope. Various ranges of dyes and pigments can be used to color the alginate-based fibers, yarns, or textiles of the present application without affecting the inherent chemistry or mechanical properties of the alginate-based fibers, yarns or textiles, including natural, non-toxic, or biosynthetic dyes or pigments.

### EXAMPLES

### Example 1

A sodium malate solution was prepared by dissolving 0.54 parts by weight malic acid and 8.0 parts by volume 1.0M aqueous NaOH in about 65 parts water. To this solution was added 7 parts by weight low molecular weight, high G sodium alginate ALGIN™ IL-6G (Kimica, Tokyo, Japan) and 20 parts by weight distilled water, and the mixture was stirred until all the alginate was dissolved. After entrained air was removed, the solution was filtered with 3 μm filter, and extruded through a 150 μm spinneret at a rate of 0.14 grams per hole per minute. The fiber was pulled through a 1 meter coagulation bath, containing 0.12M CaCl₂, at 6.0 m/min It was then drawn through a distilled water bath, to remove residual calcium salts, at 8.1 m/min, and heated on a godet. Fiber was collected on a spool at 8.5 m/min. After drying under ambient conditions overnight, filaments were conditioned at 20±2° C. and 65±3% Relative Humidity before determining filament denier and measuring tensile properties. Results (average of 10 replicates per sample) can be found in Table 1.

### Example 2

Example X was repeated using a sodium tartrate solution. The sodium tartrate solution was prepared by dissolving 0.91 parts by weight sodium tartrate dihydrate in about 70 parts water. Results (average of 10 replicates per sample) can be found in Table 1.

### Example 3

Example X was repeated using a sodium/potassium glucarate solution. The sodium/potassium glucarate solution was prepared by dissolving 1.07 parts by weight of the mixed sodium/potassium glucarate in about 70 parts water. Results (average of 10 replicates per sample) can be found in Table 1.

TABLE 1

| | | | | | Elongation | Tenacity | | Elongation | Tenacity |
|---|---|---|---|---|---|---|---|---|---|
| | Molecular | G | | Denier | at Break | at Break | Modulus | at Yield | at Yield |
| Ex | Weight | Ratio | Dicarboxylate | (g/9000 m) | (%) | (g/den) | (g/den) | (%) | (g/den) |
| 1 | Low | High | Malate | 12.9 | 6.9 | 2.49 | 85 | 1.6 | 1.42 |
| 2 | Low | High | Tartrate | 13.1 | 6.6 | 1.78 | 70 | 1.7 | 1.12 |
| 3 | Low | High | Glucarate | 13.3 | 7.4 | 1.89 | 70 | 1.5 | 1.20 |

### Example 4

The following example is carried out to produce 10 denier (g/9000 m) filaments using each of the dicarboxylic acids described in Table 2. A sodium dicarboxylate solution is prepared by dissolving 0.58 parts by weight dicarboxylic acid in 85 parts by volume 0.09 M aqueous NaOH with stirring until completely dissolved. To this is added 5 parts by weight alginate salt (e.g., high molecular weight, high G sodium alginate ALGIN™ I-3G-80) and 9.5 parts distilled water and is stirred until all the alginate is dissolved. After entrained air is removed, the solution is filtered with 3 μm filter, and extruded through a 150 μm spinneret at a rate of 0.14 grams per hole per minute. The fiber is pulled through a 1 meter coagulation bath, containing 0.12 M CaCl₂, at 6.0 m/min. It is then drawn through a distilled water bath, to remove residual calcium salts, at 8.1 m/min, and heated on a Godet. Fiber is collected on a spool at 8.4 m/min. After drying under ambient conditions overnight, filaments are conditioned at 20±2° C. and 65±3% Relative Humidity before determining filament denier and measuring tensile properties (ASTM 2256).

Some filaments are crimped and cut to make staple fibers of the following lengths: 1 inch, 1.25 inch, 2 inches, 4 inches, and 6 inches.

TABLE 2

| | Dicarboxylic Acid |
|---|---|
| A | Tartaric Acid |
| B | Citramalic Acid |
| C | Malic Acid |
| D | Hydroxyglutaric Acid |
| E | Aspartic Acid |
| F | Glutamic Acid |
| G | Bromosuccinic Acid |
| H | Dihydroxyglutaric Acid |
| I | Hydroxyadipic Acid |
| J | Saccharic Acid |
| L | Oxaloacetic Acid |
| M | Chloromalonic Acid |
| N | Bromomalonic Acid |
| O | Chlorosuccinic Acid |
| R | Bromosuccinic Acid |
| S | Dibromosuccinic Acid |
| T | Bromoglutaric Acid |

### Example 5

Example 3 is repeated using the alginate salts listed in Tables 3 to produce 10 denier filaments. Some filaments are crimped and cut to make staple fibers of the following lengths: 1 inch, 1.25 inch, 2 inches, 4 inches, and 6 inches.

TABLE 3

| | Alginate | Alginate G | Alginate |
|---|---|---|---|
| | Molecular Weight | Ratio | Salt |
| A | High | Medium | Sodium |
| B | High | Low | Sodium |
| C | Medium | High | Sodium |
| D | Medium | Medium | Sodium |
| E | Medium | Low | Sodium |
| F | Low | High | Sodium |
| G | Low | Medium | Sodium |
| H | Low | Low | Sodium |

### Example 6

Examples 4 and 5 are repeated using the alginate salts listed in Tables 4 to produce 10 denier filaments. Some filaments are crimped and cut to make staple fibers of the following lengths: 1 inch, 1.25 inch, 2 inches, 4 inches, and 6 inches.

TABLE 4

| | Alginate | Alginate G | Alginate |
|---|---|---|---|
| | Molecular Weight | Ratio | Salt |
| A | High | High | Ammonium |
| B | High | Medium | Ammonium |
| C | High | Low | Ammonium |
| D | Medium | High | Ammonium |
| E | Medium | Medium | Ammonium |
| F | Medium | Low | Ammonium |
| G | Low | High | Ammonium |
| H | Low | Medium | Ammonium |
| I | Low | Low | Ammonium |
| J | High | High | Potassium |
| L | High | Low | Potassium |
| M | Medium | High | Potassium |
| N | Medium | Medium | Potassium |
| O | Medium | Low | Potassium |
| P | Low | High | Potassium |
| Q | Low | Medium | Potassium |
| R | Low | Low | Potassium |

### Example 7

The dicarboxylic acids described in Table 2 are used to prepare 2 denier filaments as described below. A sodium dicarboxylate solution is prepared by adding 1 part solid NaOH to 225 parts distilled water. To this solution is added 1.6 parts dicarboxylic acid and mixed until the dicarboxylic acid dissolves. A spinning dope is prepared by slowly adding 15 parts of an alginate to the sodium dicarboxylate solution while mixing. Once dissolved, an additional 150 parts distilled water is added to give a spinning dope containing 5% by weight sodium alginate. After entrained air is removed, this solution is filtered through a filter pack, and extruded through a 60 μm 400-hole spinneret at a rate of 4 m/min. The fiber is pulled through a coagulation bath, containing 0.12 M CaCl₂, at a rate of 4 or 12 m/min It is then washed in deionized water and treated with a fabric softener (Neutral, Unilever, London, United Kingdom) to prevent the fibers from fusing during drying. Then the fibers are dried in 80° C. for 45 min Drying is done either with filaments collected on a spool (under tension) or with the filaments cut from the spool (no tension).

Some filaments are crimped and cut to make staple fibers of the following lengths: 1 inch, 1.25 inch, 2 inches, 4 inches, and 6 inches.

### Example 8

Example 7 is repeated using the alginates described in Examples 5 and 6 to produce 2 denier filaments. Some filaments are crimped and cut to make staple fibers of the following lengths: 1 inch, 1.25 inch, 2 inches, 4 inches, and 6 inches.

### Example 9

Examples 4-8 are repeated using the following bases in place of sodium hydroxide: potassium hydroxide, ammonium hydroxide, sodium carbonate, potassium carbonate, lithium carbonate, lithium hydroxide, sodium bicarbonate, potassium bicarbonate, and lithium bicarbonate.

### Example 10

Examples 4-9 are repeated using the following cationic crosslinking agents: barium chloride, aluminum chloride, copper chloride, copper sulfate, aluminum sulfate, iron sulfate, and zinc sulfate.

### Example 11

Spun yarns are prepared using (a) 10 weight %, 25 weight %, 30 weight %, 40 weight %, 45 weight %, 50 weight %, 55 weight %, 60 weight %, 75 weight %, 90 weight % and 100 weight % of staple fibers made from the fibers of Examples 4-10 with (b) the balance being commercially available (i) 0.5 dpf, 1 dpf, 2 dpf, 3 dpf, 5 dpf and 10 dpf staple fibers of the synthetic and semi-synthetic polymers listed in Table 5 (having corresponding lengths to those of the staple fibers of the invention) or (ii) the natural fibers listed in listed in Table 5.

TABLE 5

| | Blended Yarns |
|---|---|
| A | Cotton |
| B | Wool |
| C | Viscose (Rayon) |
| D | Lyocell (Rayon) |
| E | Polylactic Acid (PLA) |
| F | Polyhydroxybutyrate (PHA) |
| G | Linen |
| H | Hemp |
| I | Silk |
| J | Chitosan |
| K | Aramid (Nomex ®) |
| L | Aramid (Kevlar ®) |
| M | Polyester (Polyethylene Terephthalate) |
| N | Polytrimethylene Terephthalate (Sorona ®) |
| O | Polybutylene Terephthalate (PBT) |
| P | Nylon 6,6 |
| Q | Nylon 6 |
| R | Nylon 6,10 |
| S | Nylon 6,12 |
| T | Nylon 5,6 |
| U | Polypropylene |
| V | Polyethylene |

### Example 12

Yarns are prepared using (a) 10 weight %, 25 weight %, 30 weight %, 40 weight %, 45 weight %, 50 weight %, 55 weight %, 60 weight %, 75 weight %, 90 weight %, and 100 weight % of continuous filaments made from the fibers of Examples 1-10 with (b) the balance being commercially available (i) 0.5 dpf, 1 dpf, 2 dpf, 3 dpf, 5 dpf and 10 dpf continuous fibers of the synthetic and semi-synthetic polymers listed in Table 6 or (ii) continuous silk fibers.

TABLE 6

| | Blended Yarns |
|---|---|
| AA | Viscose (Rayon) |
| BB | Lyocell (Rayon) |
| CC | Polylactic Acid (PLA) |
| DD | Polyhydroxybutyrate (PHA) |
| EE | Silk |
| FF | Chitosan |
| GG | Aramid (Nomex ®) |
| HH | Aramid (Kevlar ®) |
| II | Polyester (Polyethylene Terephthalate) |
| JJ | Polytrimethylene Terephthalate (Sorona ®) |
| KK | Polybutylene Terephthalate (PBT) |
| LL | Nylon 6,6 |
| MM | Nylon 6 |
| NN | Nylon 6,10 |
| OO | Nylon 6,12 |
| PP | Nylon 5,6 |
| QQ | Polypropylene |
| RR | Polyethylene |

### Example 13

Fabrics are prepared using (a) 10 weight %, 25 weight %, 30 weight %, 40 weight %, 45 weight %, 50 weight %, 55 weight %, 60 weight %, 75 weight %, 90 weight %, and 100 weight % of yarns of continuous filaments of Examples 1-10 with (b) the balance being appropriate size commercially available yarns of the materials listed in Table 7.

### Example 14

Fabrics are prepared using (a) 10 weight %, 25 weight %, 30 weight %, 40 weight %, 45 weight %, 50 weight %, 55 weight %, 60 weight %, 75 weight %, 90 weight %, and 100 weight % of yarns of staple fibers of Examples 4-10 with (b) the balance being appropriate size yarns of commercially available fibers of the materials described in Table 7.

TABLE 7

| | Blended Fabrics |
|---|---|
| A | Cotton |
| B | Wool |
| C | Viscose (Rayon) |
| D | Lyocell (Rayon) |
| E | Polylactic Acid (PLA) |
| F | Polyhydroxybutyrate (PHA) |
| G | Linen |
| H | Hemp |
| I | Silk |
| J | Chitosan |
| K | Aramid (Nomex ®) |
| L | Aramid (Kevlar ®) |
| M | Polyethylene Terephthalate (PET) |
| N | Polytrimethylene Terephthalate (Sorona ®) |
| O | Polybutylene Terephthalate (PBT) |
| P | Nylon 6,6 |
| Q | Nylon 6 |
| R | Nylon 6,10 |
| S | Nylon 6,12 |
| T | Nylon 5,6 |
| U | Polypropylene |
| V | Polyethylene |

### Example 15

Example 11 is repeated using 0.5 dpf, 1 dpf, 3 dpf and 5 dpf staple fibers of the invention with the commercial fibers described in Example 11.

### Example 16

Example 12 is repeated using 0.5 dpf, 1 dpf, 3 dpf and 5 dpf continuous filaments of the invention with the commercially available fibers described in Example 12.

### Example 17

Examples 12 and 16 are repeated with use of 1, 2, 3, 4, 5 and 10 weight % of spandex (elastane) continuous filaments having appropriate sizes (e.g., 0.5 dpf, 1 dpf, 2 dpf, 3 dpf and 5 dpf—measured in the relaxed stated prior to stretching) and stretch characteristics for desired yarn and fabric properties.

### Example 18

Examples 11 and 15 are repeated with use of 1, 2, 3, 4, 5 and 10 weight % of polyethylene terephthalate/polytrimethylene terephthalate side by side or sheath/core staple fibers having appropriate sizes (e.g., 0.5 dpf, 1 dpf, 2 dpf, 3 dpf and 5 dpf) and stretch characteristics for desired yarn and fabric properties.

### Example 19

Examples 12 and 16 are repeated with use of 1, 2, 3, 4, 5 and 10 weight % of polyethylene terephthalate/polytrimethylene terephthalate side by side or sheath/core continuous filaments having appropriate sizes (e.g., 0.5 dpf, 1 dpf, 2 dpf, 3 dpf and 5 dpf) and stretch characteristics for desired yarn and fabric properties.

### Example 20

Examples 11 and 15 are repeated using 1, 2, 3, 4, 5 and 10 weight % of polyethylene terephthalate/polybutylene terephthalate (PET/PBT) side by side or sheath/core staple fibers having appropriate sizes (e.g., 0.5 dpf, 1 dpf, 2 dpf, 3 dpf and 5 dpf) and stretch characteristics for desired yarn properties.

### Example 21

Examples 12 and 16 are repeated with use of 1, 2, 3, 4, 5 and 10 weight % of PET/PBT side by side or sheath/core continuous filaments having appropriate sizes (e.g., 0.5 dpf, 1 dpf, 2 dpf, 3 dpf and 5 dpf) and stretch characteristics for desired fabric properties.

### Example 22

Examples 12 and 16 are repeated with use of 1, 2, 3, 4, 5 and 10 weight % of melt-spun thermoplastic elastomeric continuous filaments having appropriate sizes (e.g., 0.5 dpf, 1 dpf, 2 dpf, 3 dpf,5 dpf and 10 dpf—measured in the relaxed stated prior to stretching) and stretch characteristics for desired yarn and fabric properties.

### Example 23

Yarns blends are prepared using the yarns prepared in Examples 11, 12, 15 and 16 with commercial yarns of the materials listed in Table 5. In addition, yarns were prepared using a third yarn of (a) spandex (elastane) continuous filaments having appropriate sizes (e.g., 0.5 dpf, 1 dpf, 2 dpf, 3 dpf and 5 dpf—measured in the relaxed stated prior to stretching) and stretch characteristics, (b) polyethylene terephthalate/polytrimethylene terephthalate side by side or sheath/core staple fibers having appropriate sizes (e.g., 0.5 dpf, 1 dpf, 2 dpf, 3 dpf and 5 dpf) and stretch characteristics for desired properties, (c) polyethylene terephthalate/polytrimethylene terephthalate side by side or sheath/core continuous filaments having appropriate sizes (e.g., 0.5 dpf, 1 dpf, 2 dpf, 3 dpf and 5 dpf) and stretch characteristics for desired properties, (d) polyethylene terephthalate/polybutylene terephthalate (PET/PBT) side by side or sheath/core staple fibers having appropriate sizes (e.g., 0.5 dpf, 1 dpf, 2 dpf, 3 dpf and 5 dpf) and stretch characteristics for desired properties, and (e) PET/PBT side by side or sheath/core continuous filaments having appropriate sizes (e.g., 0.5 dpf, 1 dpf, 2 dpf, 3 dpf and 5 dpf) and stretch characteristics for desired properties. Fabrics are made of each of these yarns.

The following measurement techniques are used for the Examples.

### Denier

Denier is a linear density unit which is the mass in grams per 9000 meters of a fiber. Denier is determined using two different methods. For monofilament, denier is measured by collecting a known length of fiber, conditioning it in a climate chamber (22±3° C. and 65±5%) for at least 24 hours, and then measuring the weight. For multifilament, individual strand denier is measured through the use of a VIBROSKOP/VIBRODYN from Lenzing Technik (Austria).

### Tensile Measurement

For individual filaments, tensile measurements are obtained using an EXPERT 7600 from ADMET (Norwood, Massachusetts, USA) at 50 8 mm/min and a clamp distance of 164 mm on conditioned fibers at 20±2° C. and 65±3% relative humidity for at least 12 hours (ASTM 2256). For individual filaments, individual strand tensile measurements are obtained using a VIBROSKOP/VIBRODYN from Lenzing Technik (Austria) at 20 mm min-1 and a clamp distance of 20 mm on conditioned fibers at 20±2° C. and 65±3% relative humidity (EN ISO 5079).

Other embodiments of the present disclosure will be apparent to those skilled in the art from consideration of the present specification and practice of the present disclosure disclosed herein. It is intended that the present specification and examples be considered as exemplary only with a true scope and spirit of the disclosure being indicated by the following claims and equivalents thereof.

1. A polymer comprising an alginate which is ionically crosslinked with hetero-substituted dicarboxylate-bridged multivalent cations wherein the dicarboxylates are present in at least about 0.05 molar equivalents with respect to the alginate carboxylate content.

2. A polymer comprising an alginate which is ionically crosslinked with hetero-substituted dicarboxylate-bridged multivalent cations, wherein the polymer is made by a process involving reacting alginate salt with at least about 1%, based on the weight of the alginate salt, of at least one hetero-substituted dicarboxylate.

3. The polymer of claim 1 wherein the dicarboxylates are present in the range of about 0.1 to about 0.75 molar equivalents with respect to the alginate carboxylate content and wherein the polymer is made by a process involving reacting alginate salt with about 5% to about 75%, based on the weight of the alginate salt, of at least one hetero-substituted dicarboxylate.

4. The polymer of claim 1 made by a process comprising:
a. combining:
i. at least one monovalent cationic alginate salt;
ii. at least one C₃ -C₂₀ hetero-substituted dicarboxylate; and
iii. at least one multivalent cationic crosslinking agent; and
b. reacting them to form the polymer.

5. A process of preparing the polymer of claim 1 comprising:
a. combining:
i. at least one monovalent cationic alginate salt;
ii. at least one C₃ -C₂₀ hetero-substituted dicarboxylate; and
iii. at least one multivalent cationic crosslinking agent; and
b. reacting them to form the polymer.

6. A process of preparing a shaped article from a polymer of claim 1 comprising:
a. shaping the polymer to form a shaped article.

7. A process of preparing a fiber of the polymer of claim 1 by a wet spinning process which comprises:
a. Preparing a dope of at least one monovalent metal alginate salt and an at least one C₃ -C₂₀ hetero-substituted dicarboxylate in solvent;
b. Extruding the dope through a spinneret to form fibers;
c. Drawing the fibers through at least one coagulation bath containing solvent and at least one multivalent cationic crosslinking agent; and
d. Drying the fibers.

8. The process of claim 7 wherein:
a. the alginate salt is selected from the group consisting of sodium, potassium and ammonium alginate;
b. the alginate salt has a molecular weight of about 10,000 grams/mole to about 500,000 grams/mol and has G/M ratio of about 1 to about 2.5;
c. the hetero-substituted dicarboxylate is sodium, potassium, lithium, or ammonium hetero-substituted dicarboxylate;
d. the dope comprises about 0.5 to about 50% by weight of the monovalent metal alginate salt, by weight of the dope;
e. the dope is prepared with about 1 to about 125% of the at least one unsubstituted dicarboxylate based on the weight of the alginate salt;
f. the multivalent cationic crosslinking agent has cations selected from the group consisting of calcium, copper, iron, aluminum, zinc, magnesium, barium, chromium, cobalt, nickel, manganese, and mixtures thereof; and
g. the coagulation bath contains about 0.02 to about 2 moles per liter of the at least one multivalent cationic crosslinking agent in the solvent.

9. The process of claim 8 wherein the solvent of the dope is water and the solvent of the coagulation bath is water.

10. A fiber prepared from the polymer of claim 1.

11. The polymer of claim 1, wherein the dicarboxylate is derived from a dicarboxylic acid having the following formula: 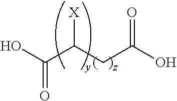
wherein y and z total 1-18; y is 1-18 and z is 0-17; X is OR', NR₂R₃, halogen and ═O; and R₁, R₂ and R₃, which may be the same or different, are selected from C₁-C₈ linear, branched, or cyclic alkyl groups or hydrogen.

12. The polymer of claim 1, wherein the hetero-substituted dicarboxylate is a hydroxyl substituted dicarboxylate derived from a dicarboxylic acid selected from the group consisting of tartronic acid, malic acid, tartaric acid, citramalic acid, hydroxyglutaric acid, dihydroxyglutaric acid, hydroxyadipic acid, and saccharic acid.

13. The polymer of claim 1, wherein the hetero-substituted dicarboxylate is an C₃ -C₁₂ amino-substituted dicarboxylate.

14. The polymer of claim 1, wherein the hetero-substituted dicarboxylate is a halogen-substituted dicarboxylate derived from a dicarboxylic acid selected from the group consisting of chloromalonic acid, bromomalonic acid, chlorosuccinic acid, bromosuccinic acid, dibromosuccinic acid, and bromoglutaric acid.

15. The polymer of claim 1, wherein the hetero-substituted dicarboxylate is a C₃ -C₁₂ keto-substituted dicarboxylate.

16. The polymer of claim 13, wherein the amino-substituted dicarboxylic acid is selected from the group consisting of aspartic acid and glutamic acid.

17. The process of claim 7, wherein the dicarboxylic acid has the following formula: 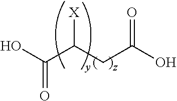
wherein y and z total 1-18; y is 1-18 and z is 0-17; X is OR₁, NR₂R₃, halogen and ═O; and R₁, R₂ and R₃, which may be the same or different, are selected from C₁-C₈ linear, branched, or cyclic alkyl groups or hydrogen.

18. The process of claim 7, wherein the hetero-substituted dicarboxylate is an C₃ -C₁₂ amino-substituted dicarboxylate.

19. The process of claim 18, wherein the amino-substituted dicarboxylic acid is selected from the group consisting of aspartic acid and glutamic acid.

20. A fiber prepared by the process of claim 7.
